(19) United States
(12) Patent Application Publication
(10) Pub. No.: US 2025/0060697 A1
(43) Pub. Date: Feb. 20, 2025

(54) IMAGE FORMING APPARATUS AND NON-TRANSITORY COMPUTER-READABLE STORAGE MEDIUM STORING TONER CLOGGING DETECTION PROGRAM

(71) Applicant: FUJIFILM Business Innovation Corp., Tokyo (JP)

(72) Inventor: Ryosuke HASEGAWA, Kanagawa (JP)

(73) Assignee: FUJIFILM Business Innovation Corp., Tokyo (JP)

(21) Appl. No.: 18/591,506

(22) Filed: Feb. 29, 2024

(30) Foreign Application Priority Data
Aug. 16, 2023 (JP) 2023-132520

(51) Int. Cl. G03G 21/10; G03G 15/00; G03G 15/10

(52) U.S. Cl. CPC G03G 21/10; G03G 15/105; G03G 15/5008; G03G 15/5016

(57) ABSTRACT

An image forming apparatus includes: a waste toner collection path through which waste toner is collected; a motor that drives a conveyance member provided in the waste toner collection path; and a processor that acquires a phase-to-phase voltage which is at least one in-phase voltage of the motor, and detects a sign of toner clogging in the waste toner collection path, based on a variation in the phase-to-phase voltage.

### CROSS-REFERENCE TO RELATED APPLICATIONS

This application is based on and claims priority under 35 USC 119 from Japanese Patent Application No. 2023-132520 filed Aug. 16, 2023.

### BACKGROUND

### (i) Technical Field

The present invention relates to an image forming apparatus and a non-transitory computer-readable storage medium storing a toner clogging detection program.

### (ii) Related Art

For example, JP2000-066556A describes a waste toner conveyance apparatus in which a rotary conveyance member for conveying toner is provided in a pipe and is rotated by a drive means to convey waste toner remaining on an image carrier to a waste toner receiver. The waste toner conveyance apparatus includes a control means for comparing a driving current value of a rotary drive source of the drive means with a predetermined driving current value and determining that clogging of the waste toner pipe has occurred, when the driving current value exceeds the predetermined driving current value.

### SUMMARY

Meanwhile, in an image forming apparatus, a conveyance member in a waste toner collection path is driven by a motor to convey waste toner. As a means for detecting toner clogging in the waste toner collection path, for example, there is a technique in which a DC motor is used as a drive source and a driving current of the motor is monitored to detect toner clogging.

However, although the occurrence of the toner clogging can be detected, a sign of the toner clogging cannot be detected.

Aspects of non-limiting embodiments of the present disclosure relate to an image forming apparatus capable of detecting a sign of toner clogging in a waste toner collection path, and a non-transitory computer-readable storage medium storing a toner clogging detection program.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to a first aspect, there is provided an image forming apparatus comprising: a waste toner collection path through which waste toner is collected; a motor that drives a conveyance member provided in the waste toner collection path; and a processor that acquires a phase-to-phase voltage which is at least one in-phase voltage of the motor, and detects a sign of toner clogging in the waste toner collection path, based on a variation in the phase-to-phase voltage.

### BRIEF DESCRIPTION OF THE DRAWINGS

Exemplary embodiments of the present invention will be described in detail based on the following figures, wherein:

FIG. 1 is a diagram illustrating an example of a configuration of an image forming apparatus according to an exemplary embodiment;

FIG. 2 is a diagram illustrating an example of a configuration of an image forming unit;

FIG. 3 is a diagram illustrating an example of a configuration of a main part of a waste toner collection path;

FIG. 4 is a diagram illustrating an example of a motor;

FIG. 5 is a block diagram illustrating an example of an electrical configuration of the image forming apparatus according to the exemplary embodiment;

FIG. 6 is a block diagram illustrating an example of a functional configuration of the image forming apparatus according to the exemplary embodiment;

FIG. 7 is a diagram illustrating an example of a relationship among a zero-cross timing, a CLK signal, and a DIR signal according to the exemplary embodiment;

FIG. 8 is a diagram illustrating an example of a waveform of a phase-to-phase voltage during the zero-cross timing;

FIG. 9 is a graph illustrating an example of a relationship between a load torque and the phase-to-phase voltage of the motor; and

FIG. 10 is a flowchart illustrating an example of a flow of processing by a toner clogging detection program according to the exemplary embodiment.

### DETAILED DESCRIPTION

In the following, an example of a mode for carrying out the technique of the present disclosure will be described in detail with reference to the drawings. Note that constituent elements and processes that have the same operation, action, and function are denoted by the same reference signs throughout the drawings, and the redundant description may be omitted as appropriate. Each of the drawings is merely schematically illustrated to the extent that the technique of the present disclosure can be sufficiently understood. Therefore, the technique of the present disclosure is not limited to only the examples illustrated in the drawings. Furthermore, in an exemplary embodiment, descriptions on configurations that are not directly related to the technique of the present disclosure and descriptions on well-known configurations may be omitted.

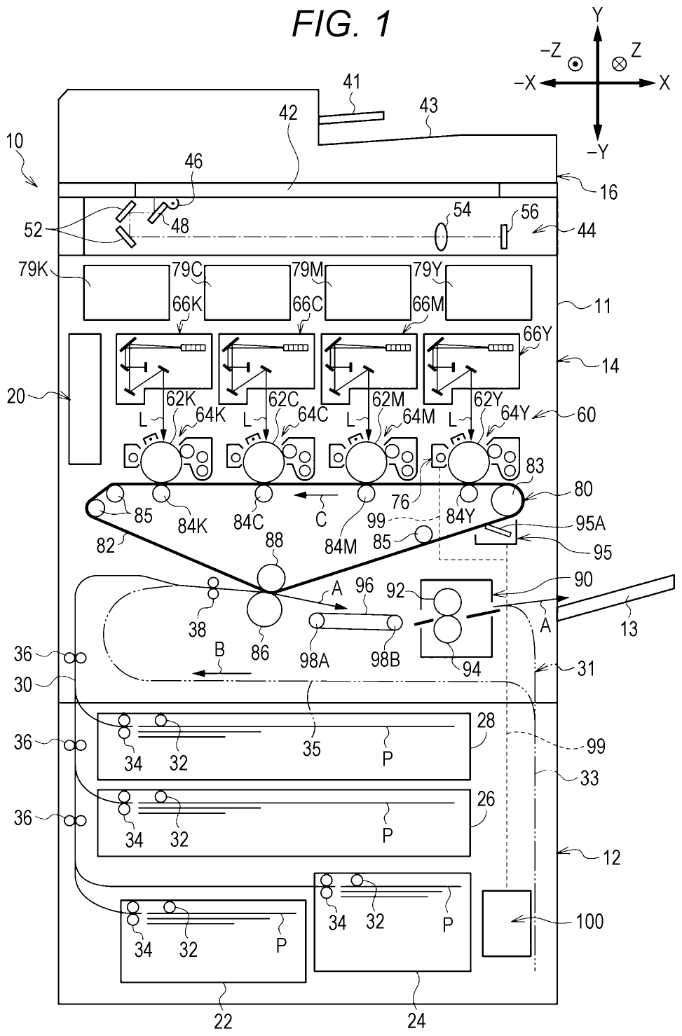

FIG. 1 is a diagram illustrating an example of a configuration of an image forming apparatus 10 according to an exemplary embodiment. The image forming apparatus 10 is provided with a sheet-of-paper accommodation section 12, a main operation section 14, and a document read section 16 from a lower side to an upper side in an up-and-down direction (Y direction), and the main operation section 14 is provided with a control device 20 that controls operation in each section of the image forming apparatus 10.

In front view of the image forming apparatus 10 from a side on which a user (not illustrated) stands, an X direction corresponds to a right direction, a −X direction corresponds to a left direction, a Y direction corresponds to an upper direction, a-Y direction corresponds to a lower direction, a Z direction corresponds to a depth direction, and a-Z direction corresponds to a front direction.

The sheet-of-paper accommodation section 12 includes a first accommodation portion 22, a second accommodation portion 24, a third accommodation portion 26, and a fourth accommodation portion 28 that can accommodate recording sheets of paper P as an example of recording media of different sizes. Each of the first accommodation portion 22, the second accommodation portion 24, the third accommodation portion 26, and the fourth accommodation portion 28 is provided with a feed roller 32 that feeds the accommodated recording sheets of paper P one by one, and a conveyance roller 34 that conveys the fed recording sheets of paper P to a conveyance path 30 provided in the image forming apparatus 10.

Furthermore, a plurality of conveyance rollers 36 that convey the recording sheets of paper P one by one are provided on the downstream side of the conveyance rollers 34 in the conveyance path 30. Furthermore, a registration roller 38 that temporarily stops the recording sheets of paper P and feeds them to a below-described secondary transfer position at a determined timing to thereby perform registration of image transfer is provided on the downstream side of the conveyance rollers 36 in the conveyance path 30 in the direction of conveying the recording sheets of paper P in the main operation section 14.

In front view of the image forming apparatus 10, an upstream-side portion of the conveyance path 30 is provided linearly from a −X direction side of the sheet-of-paper accommodation section 12 to a −X direction-side lower portion of the main operation section 14 in the Y direction indicated by an arrow. A downstream-side portion of the conveyance path 30 is provided from the −X direction-side lower portion of the main operation section 14 to a sheet-of-paper ejection section 13 provided on an X direction-side surface of the main operation section 14. Furthermore, the conveyance path 30 is connected to a duplex conveyance path 31 to and at which the recording sheets of paper P are conveyed and reversed in order to perform image formation on both sides of each recording sheet of paper P. Note that the direction of conveying the recording sheets of paper P when duplex conveyance is not performed is indicated by arrow A.

In front view of the image forming apparatus 10, the duplex conveyance path 31 includes a reverse portion 33 that is linearly provided in the Y direction indicated by the arrow from an X direction-side lower portion of the main operation section 14 to an X direction side of the sheet-of-paper accommodation section 12, and a conveyance portion 35 that conveys the recording sheets of paper P to a −X direction side (indicated by arrow B) as illustrated. A downstream-side end of the conveyance portion 35 is connected to the conveyance path 30 on an upstream side of the registration roller 38 by a guide member (not illustrated).

The conveyance portion 35 conveys the recording sheets of paper P to the −X direction side (indicated by arrow B) as illustrated while the rear end of each recording sheet of paper P conveyed to the reverse portion 33 enters. Note that a plurality of conveyance rollers that are provided at intervals in the reverse portion 33 and conveyance portion 35 are not illustrated in FIG. 1. Furthermore, a switching member that performs switching between the conveyance path 30 and the duplex conveyance path 31 and a reverse feed prevention member that prevents the recording sheets of paper P from being fed in reverse from the reverse portion 33 to the conveyance path 30 are not illustrated.

Further, a waste toner collection container 100 is detachably mounted between the second accommodation portion 24 and the reverse portion 33 in the sheet-of-paper accommodation section 12. Note that the direction of attaching the waste toner collection container 100 to an apparatus main body 11 is the Z direction, and the direction of detaching the waste toner collection container 100 from the apparatus main body 11 is the −Z direction. Note that the place where the waste toner collection container 100 is mounted is not particularly limited.

The document read section 16 is provided with a document table 41 on which a plurality of documents (not illustrated) are placed, a platen glass 42 on which one document is placed, a document read device 44 that reads each document on the platen glass 42, and a document discharge portion 43 to which the read documents are discharged.

The document read device 44 includes a light irradiation unit 46, one full-rate mirror 48, two half-rate mirrors 52, an imaging lens 54, and a photoelectric conversion element 56. The light irradiation unit 46 irradiates each document placed on the platen glass 42 with light. Next, the full-rate mirror 48 and the half-rate mirrors 52 reflect and fold back reflected light, which is irradiated by the light irradiation unit 46 and is reflected from the document, in a direction parallel to the platen glass 42.

The imaging lens 54 is arranged so that the reflected light folded back by the full-rate mirror 48 and half-rate mirrors 52 enters the imaging lens 54. The photoelectric conversion element 56 converts the reflected light imaged by the imaging lens 54 into an electric signal. The electric signal converted by the photoelectric conversion element 56 is subjected to image processing by an image processing apparatus (not illustrated) and used for image formation. Furthermore, the full-rate mirror 48 moves along the platen glass 42 at a full rate, and the half-rate mirrors 52 move along the platen glass 42 at a half rate. The imaging lens 54 and the photoelectric conversion element 56 are stationary.

In the main operation section 14, an image forming portion 60 that forms a toner image (developing agent image) on each recording sheet of paper P and a fixing device 90 that fixes the toner image on the recording sheet of paper P formed by the image forming portion 60 are provided in the apparatus main body 11 that includes a plurality of frames.

The image forming portion 60 includes image forming units 64Y, 64M, 64C, and 64K that are provided in correspondence with the respective kinds of toner of yellow (Y), magenta (M), cyan (C), and black (K), exposure units 66Y, 66M, 66C, and 66K, and a transfer unit 80. The image forming units 64Y, 64M, 64C, and 64K include photosensitive bodies 62Y, 62M, 62C, and 62K, respectively. In the following description, in a case where it is necessary to distinguish Y, M, C, and K from each other, any one of the letters Y, M, C, and K is added to the end of a numeral, and in a case where it is not necessary to distinguish Y, M, C, and K from each other in the same configuration, the description of Y, M, C, and K is omitted.

The exposure unit 66 is configured to scan a light beam emitted from a light source (not illustrated) by a rotary polygon mirror (not denoted by a reference sign), reflect the light beam by a plurality of optical components (not illustrated) including a reflecting mirror, and emit the light beam L corresponding to each kind of toner toward the photosensitive body 62. The photosensitive body 62 is provided below (on a-Y direction side of) the exposure unit 66.

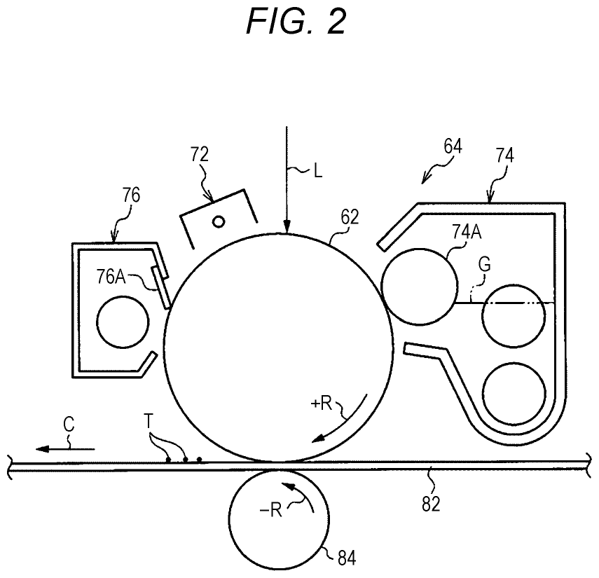

FIG. 2 is a diagram illustrating an example of a configuration of the image forming unit 64. As illustrated in FIG. 2, the image forming unit 64 includes the photosensitive body 62 as well as a charger 72, a developer 74, and a first cleaning unit 76 that are arranged in this order from the upstream side to the downstream side in the rotating direction so as to face an outer peripheral surface of the photosensitive body 62. Note that the charger 72 and the developer 74 are arranged such that the light beam L is emitted to a position between the charger 72 and the developer 74 on the outer peripheral surface of the photosensitive body 62. An intermediate transfer belt 82 is in contact with the outer peripheral surface of the photosensitive body 62 at a position between the developer 74 and the first cleaning unit 76.

The photosensitive body 62 includes a cylindrical base (not illustrated) that is formed of aluminum or the like, is electrically conductive, and is grounded, and a surface layer (not illustrated) that includes a charge generation layer, a charge transport layer, and a protective layer sequentially stacked in the radial direction on an outer peripheral surface of the base. The photosensitive body 62 is driven by a motor (not illustrated) so as to be rotatable in the +R direction indicated by an arrow (clockwise direction as illustrated).

The charger 72 is, for example, a corotron charging means that applies a voltage to a wire to cause corona discharge, thereby electrically charging the outer peripheral surface of the photosensitive body 62 to the same polarity as that of the toner. Here, the electrically charged outer peripheral surface of the photosensitive body 62 is irradiated with the light beam L based on image data, so that a latent image (electrostatic latent image) is formed.

The developer 74 accommodates a developing agent G as a mixture of toner T and carrier particles made of a magnetic material, and is provided with a cylindrical developing sleeve 74A in which a magnet roller (not illustrated) having a plurality of magnetic poles in the circumferential direction is provided. Furthermore, as the developing sleeve 74A rotates, the developer 74 forms a magnetic brush at a position facing the photosensitive body 62. When a developing bias is applied to the developing sleeve 74A by a voltage applying means (not illustrated), the developer 74 visualizes the latent image on the outer peripheral surface of the photosensitive body 62 with the toner to form a toner image (developing agent image).

Note that the toner T is supplied to each developer 74 from each toner cartridge 79 (see FIG. 1) provided above the image forming portion 60. Further, the developing agent G in each developer 74 is collected into the waste toner collection container 100 (see FIG. 1) via a later-described waste toner collection path 99 (see FIG. 1) when a consumption period based on the number of sheets of paper on which images have been formed or the like has elapsed.

The first cleaning unit 76 has a cleaning blade 76A that is disposed with its distal end directed in the rotating direction of the photosensitive body 62 and is in contact with the outer peripheral surface of the photosensitive body 62. The first cleaning unit 76 accumulates (collects) residual toner remaining on the outer peripheral surface of the photosensitive body 62 (hereinafter, such toner is referred to as “waste toner”) in such a manner that the waste toner is scraped off by the cleaning blade 76A. In addition, the intermediate transfer belt 82 to which the toner image developed by the developer 74 is primarily transferred is provided on a downstream side of the developer 74 in the rotating direction of the photosensitive body 62.

As illustrated in FIG. 1, the transfer unit 80 includes the intermediate transfer belt 82, a primary transfer roller 84, a secondary transfer roller 86, and an auxiliary roller 88.

The intermediate transfer belt 82 is formed of, for example, a film-shaped endless belt in which carbon black (antistatic agent) is contained in a resin made of polyimide or polyamide. A driving roller 83 that is disposed near the image forming unit 64Y and the primary transfer roller 84Y and is rotationally driven by a motor (not illustrated) and a plurality of conveyance rollers 85 that are rotatably provided are disposed inside the intermediate transfer belt 82. The intermediate transfer belt 82 is wound around the driving roller 83, the plurality of conveyance rollers 85, and the auxiliary roller 88. Thus, when the driving roller 83 rotates in the counterclockwise direction as illustrated, the intermediate transfer belt 82 circumferentially moves in a C direction indicated by an arrow (counterclockwise direction as illustrated).

The primary transfer roller 84 has, for example, a configuration in which a sponge layer (not illustrated) is formed around a columnar shaft made of a metal such as stainless steel, and is rotatable in such a manner that both ends of the shaft are supported by bearings. A voltage having a polarity opposite to that of the toner is applied to the shaft of the primary transfer roller 84 from a power source (not illustrated), and the primary transfer roller 84 primarily transfers the toner image from the photosensitive body 62 onto the intermediate transfer belt 82.

For example, the secondary transfer roller 86 has the same configuration as that of the primary transfer roller 84, and is rotatably provided and disposed on a downstream side of the registration roller 38 in the conveyance path 30. Further, the secondary transfer roller 86 is in contact with the outer peripheral surface of the intermediate transfer belt 82 so as to sandwich the intermediate transfer belt 82 in cooperation with the auxiliary roller 88. Note that the secondary transfer roller 86 is grounded, and the toner images sequentially superimposed on the intermediate transfer belt 82 are secondarily transferred to each recording sheet of paper P by a potential difference from the later-described auxiliary roller 88.

The auxiliary roller 88 forms a counter electrode of the secondary transfer roller 86, and a secondary transfer voltage is applied to the auxiliary roller 88 via a power supply roller (not illustrated) that is made of a metal and is disposed in contact with the outer peripheral surface of the auxiliary roller 88. Here, when the secondary transfer voltage is applied to the auxiliary roller 88, a potential difference is generated between the auxiliary roller 88 and the secondary transfer roller 86. Thus, the toner images on the intermediate transfer belt 82 are secondarily transferred onto each recording sheet of paper P conveyed to the contact portion between the secondary transfer roller 86 and the intermediate transfer belt 82.

In addition, a second cleaning unit 95 that removes and accumulates residual toner and paper dust on the intermediate transfer belt 82 after the secondary transfer is provided at a position facing the outer peripheral surface of the intermediate transfer belt 82 in the vicinity of the driving roller 83.

The second cleaning unit 95 includes a cleaning blade 95A having one end secured to a housing and the other end (free end) brought into contact with the intermediate transfer belt 82. Here, one upper end of the waste toner collection path 99, through which the waste toner scraped off by the cleaning blade 95A is conveyed to the downstream side, is connected to the second cleaning unit 95. The waste toner collection container 100 is connected to a lower end of the waste toner collection path 99. Thus, the waste toner accumulated by the second cleaning unit 95 is conveyed to the waste toner collection container 100.

Further, another upper end of the waste toner collection path 99, through which the waste toner is conveyed to the downstream side, is connected to the first cleaning unit 76. Thus, the waste toner accumulated by the first cleaning unit 76 is conveyed to the waste toner collection container 100 through the waste toner collection path 99.

For example, a seal member (not illustrated) that reflects light is secured at a reference position of a non-transfer region where the toner image is not transferred on the outer peripheral surface of the intermediate transfer belt 82. In addition, a position sensor (not illustrated) that detects a reference position of the intermediate transfer belt 82 by irradiating the non-transfer region of the intermediate transfer belt 82 with light and receiving the light reflected off the seal member is provided at a position capable of facing the seal member. As a result, in the image forming portion 60, the image forming operation of each portion is performed based on the signal of the reference position obtained by the position sensor.

As illustrated in FIG. 1, a conveyance belt 96 that conveys the recording sheets of paper P, on which the secondary transfer of the toner image has been completed, to the later-described fixing device 90 is provided on a downstream side of the secondary transfer roller 86 in the moving direction of the recording sheets of paper P. The conveyance belt 96 is provided to be capable of circling so as to convey the recording sheets of paper P to the fixing device 90 by a support roller 98A, a driving roller 98B, and a drive means (not illustrated) having a motor and a gear.

For example, the fixing device 90 includes a heat roller 92 that is heated by a halogen lamp (not illustrated) as a heat source, and a press roller 94 that is biased toward the heat roller 92 and sandwiches and presses each recording sheet of paper P in cooperation with the heat roller 92. Then, when each of the recording sheets of paper P, on which the secondary transfer has been completed, enters between the heat roller 92 and the press roller 94, the fixing device 90 fixes the toner image to the recording sheet of paper P by the action of heat and pressure.

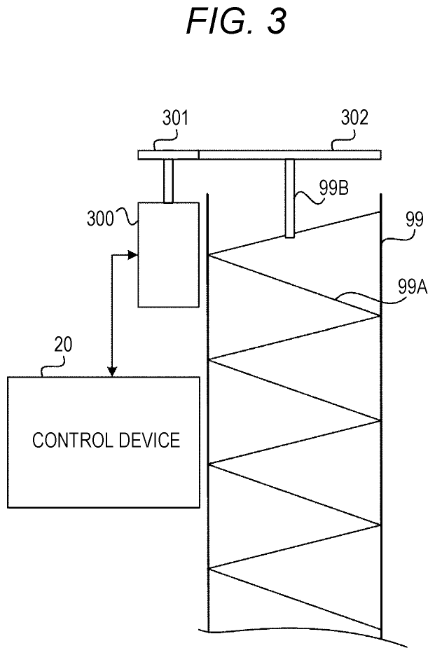

FIG. 3 is a diagram illustrating an example of a configuration of a main part of the waste toner collection path 99. As illustrated in FIG. 3, a conveyance member 99A that rotates to convey the waste toner to the waste toner collection container 100 is provided inside the waste toner collection path 99. The conveyance member 99A is, for example, a screw member. The conveyance member 99A has a drive shaft 99B, and a motor 300 is connected to the drive shaft 99B via a gear 301 and a gear 302. The motor 300 is a motor that drives the conveyance member 99A, and is driven and controlled by the control device 20. For example, a stepping motor is used as the motor 300.

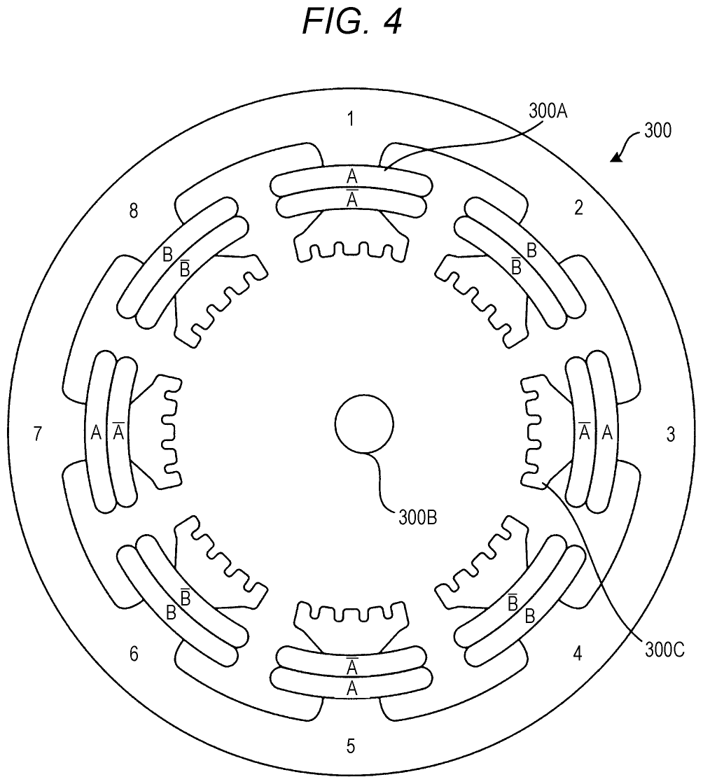

FIG. 4 is a diagram illustrating an example of the motor 300. The motor 300 illustrated in FIG. 4 is, for example, a stepping motor. The stepping motor is a motor that does not continuously rotate a motor shaft but intermittently rotates the motor shaft at a certain rotation angle. The rotation angle and the rotation speed can be controlled by a pulse signal for repeatedly turning on and off the power source.

As illustrated in FIG. 4, the motor 300 includes a stator 300A around which a winding is wound and a rotor 300B in which permanent magnets magnetized in the axial direction are inserted. By switching an excitation current of the phase winding of the stator 300A, the motor 300 is rotated at a rotation angle and a step angle specific to the motor 300. Here, for example, a two-phase unipolar type stepping motor with a step angle of 1.8° is illustrated, but the stepping motor is not limited to this type. In the stator, eight magnetic poles 300C are arranged at intervals of 45°, and in each magnetic pole 300C, five teeth are arranged at intervals of 7.2°. The motor 300 has, for example, a two-phase configuration of an A phase and a B phase. The A phase has an A phase and an A- (- is above A) phase, and the B phase has a B phase and a B- (- is above B) phase.

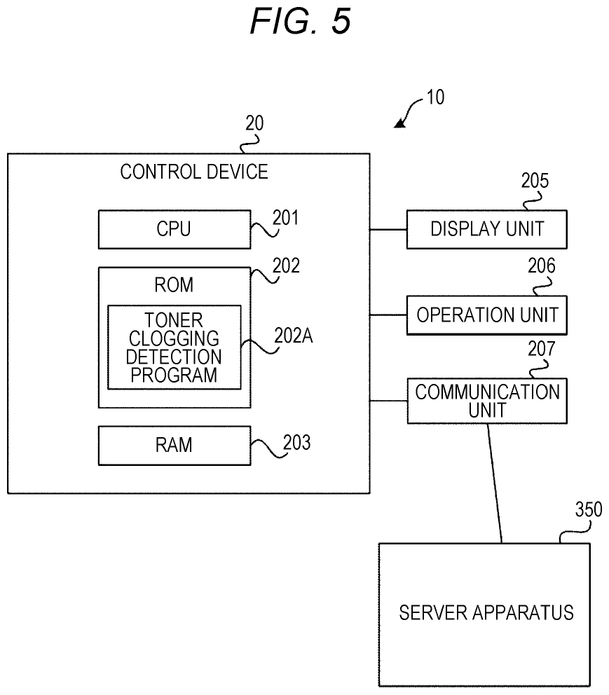

FIG. 5 is a block diagram illustrating an example of an electrical configuration of the image forming apparatus 10 according to the exemplary embodiment.

As illustrated in FIG. 5, the image forming apparatus 10 according to the exemplary embodiment includes the control device 20, a display unit 205, an operation unit 206, and a communication unit 207. The control device 20 includes a central processing unit (CPU) 201, a read only memory (ROM) 202, and a random access memory (RAM) 203. Functional units including the display unit 205, the operation unit 206, and the communication unit 207 are connected to the control device 20. These functional units can communicate with the CPU 201.

A toner clogging detection program 202A according to the exemplary embodiment is stored in the ROM 202. The toner clogging detection program 202A may be installed in advance in the image forming apparatus 10, for example. The toner clogging detection program 202A may be stored in a non-volatile storage medium or distributed via a network, and may be appropriately installed in the image forming apparatus 10. Note that examples of the non-volatile storage medium include a compact disc read only memory (CD-ROM), a magneto-optical disk, an HDD, a digital versatile disc read only memory (DVD-ROM), a flash memory, and a memory card.

As the display unit 205, for example, a liquid crystal display (LCD), an organic electro luminescence (EL) display, or the like is used. The display unit 205 may integrally include a touch panel. The operation unit 206 is provided with, for example, various operation keys such as a numeric keypad and a start key. The display unit 205 and the operation unit 206 function as an operation panel to receive instructions related to various image processing functions and settings from a user of the image forming apparatus 10. The various instructions include, for example, an instruction to start reading a document, an instruction to start copying a document, and an instruction to print out print data held in the image forming apparatus 10. The display unit 205 displays various kinds of information such as a result of processing executed in response to an instruction received from a user and a notification for the processing.

The communication unit 207 is a communication interface for connecting to a network such as the Internet, a local area network (LAN), or a wide area network (WAN), and can communicate with a server apparatus 350 via the network. The server apparatus 350 is connected to a terminal apparatus (including a portable terminal) used by a person in charge of maintenance service, and has a function of notifying the person in charge of maintenance service of various maintenance services performed in the image forming apparatus 10.

Here, for example, according to a technique in which a DC motor is used as a drive source and a driving current of the motor is monitored to detect toner clogging, although the occurrence of the toner clogging can be detected, a sign of the toner clogging cannot be detected.

For this reason, the image forming apparatus 10 according to the exemplary embodiment acquires a phase-to-phase voltage which is at least one in-phase voltage of the motor 300, and detects a sign of toner clogging in the waste toner collection path 99, based on a variation in the phase-to-phase voltage. Note that the phase-to-phase voltage according to the exemplary embodiment represents, for example, a voltage between the A phase and the A-phase and a voltage between the B phase and the B-phase, and does not include a phase-to-phase voltage between the A phase and the B phase. The phase-to-phase voltage does not vary when the load torque is normal, that is, toner clogging does not occur, and varies when the load torque has some abnormality, that is, there is a sign of the toner clogging. Therefore, by using the phase-to-phase voltage, it is possible to accurately detect a sign of toner clogging based on the abnormality of load torque.

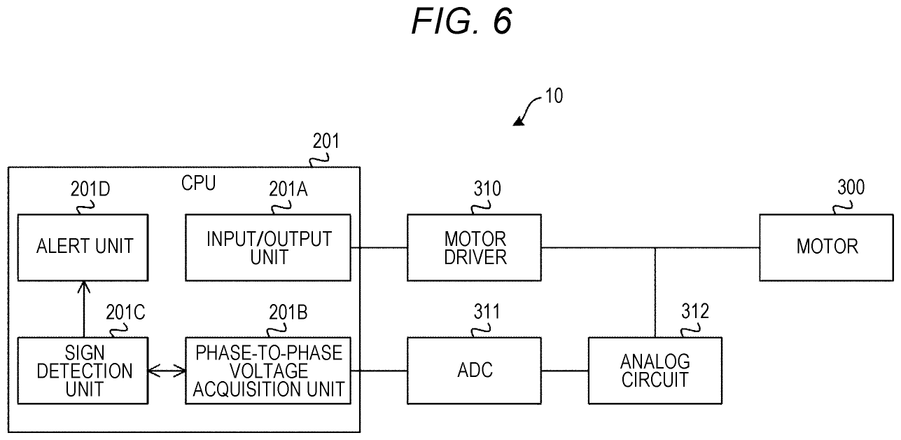

To be specific, the CPU 201 of the image forming apparatus 10 according to the exemplary embodiment functions as each unit illustrated in FIG. 6, by writing the toner clogging detection program 202A stored in the ROM 202 into the RAM 203 and executing the toner clogging detection program 202A. The CPU 201 is an example of a processor.

FIG. 6 is a block diagram illustrating an example of a functional configuration of the image forming apparatus 10 according to the exemplary embodiment.

As illustrated in FIG. 6, the CPU 201 of the image forming apparatus 10 according to the exemplary embodiment functions as an input/output unit 201A, a phase-to-phase voltage acquisition unit 201B, a sign detection unit 201C, and an alert unit 201D. Furthermore, the image forming apparatus 10 includes a motor driver 310, an analog circuit 311, and an analog-digital converter (ADC) 312.

The motor driver 310 is connected to the input/output unit 201A and is also connected to the motor 300. The motor driver 310 receives input of pulse signals of an enable (ENABLE) signal, a clock (CLK) signal, a duty (Duty) signal, and a direction (DIR) signal from the input/output unit 201A. The motor driver 310 applies a drive voltage to the motor 300 in accordance with each received pulse signal, and controls the driven motor 300.

The analog circuit 311 is connected to a control line connecting the motor 300 and the motor driver 310, and acquires an analog signal of a phase-to-phase voltage which is at least one of the voltage between the A phase and the A-phase of the motor 300 and the voltage between the B phase and the B-phase of the motor 300.

The ADC 312 is connected to the phase-to-phase voltage acquisition unit 201B, and is also connected to the analog circuit 311. The ADC 312 converts the analog signal of the phase-to-phase voltage acquired from the analog circuit 311 into a digital signal, and outputs the converted digital signal of the phase-to-phase voltage.

The phase-to-phase voltage acquisition unit 201B acquires the digital signal of the phase-to-phase voltage from the ADC 312. Specifically, the phase-to-phase voltage acquisition unit 201B acquires the digital signal of the phase-to-phase voltage at, for example, a zero-cross timing. The zero-cross timing is a timing at which an in-phase current when the motor 300 is driven becomes zero. Note that “current=0” means 0 including a predetermined error.

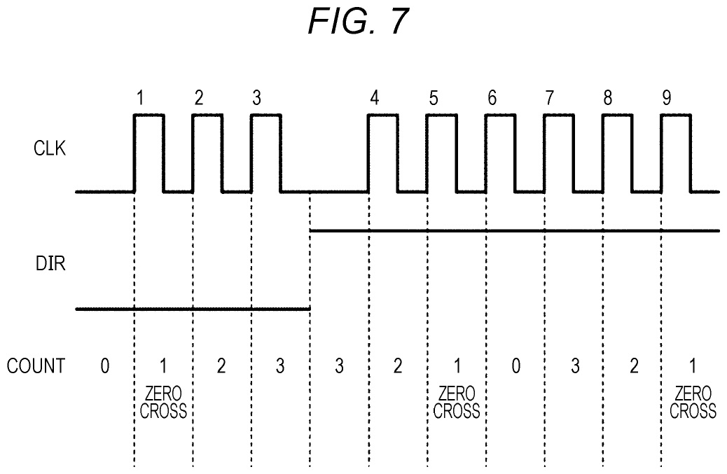

FIG. 7 is a diagram illustrating an example of a relationship among the zero-cross timing, the CLK signal, and the DIR signal according to the exemplary embodiment. As illustrated in FIG. 7, for example, the zero-cross timing is reached when a count is “1”.

The sign detection unit 201C determines occurrence of toner clogging when the phase-to-phase voltage acquired at the zero-cross timing is lower than or equal to a first threshold, determines a sign of toner clogging when the phase-to-phase voltage is higher than the first threshold and lower than or equal to a second threshold, and determines a normal state when the phase-to-phase voltage is higher than the second threshold and lower than or equal to a third threshold. Note that these first to third thresholds are stored in advance in the ROM 202. Appropriate values are set for the first to third thresholds in accordance with the specifications of the motor 300.

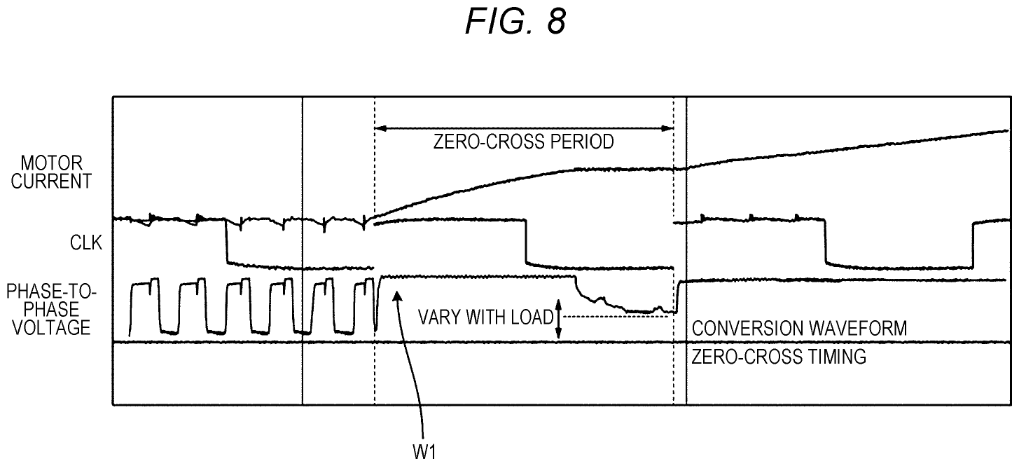

FIG. 8 is a diagram illustrating an example of a waveform of the phase-to-phase voltage during the zero-cross timing. A waveform W1 illustrated in FIG. 8 represents a waveform of the phase-to-phase voltage between the A phase and the A-phase during the zero-cross timing. The phase-to-phase voltage is 0 V in a case where the phase-to-phase voltage is not generated. On the other hand, the phase-to-phase voltage is about 10 V in a case where the phase-to-phase voltage is generated. The phase-to-phase voltage varies in accordance with the load.

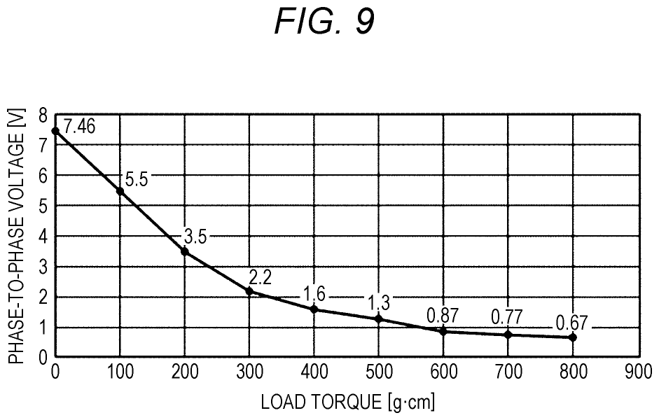

FIG. 9 is a graph illustrating an example of a relationship between the load torque and the phase-to-phase voltage of the motor 300. In FIG. 9, the vertical axis represents the phase-to-phase voltage [V], and the horizontal axis represents the load torque [g·cm]. The numerical values in FIG. 9 are merely an example, and the present disclosure is not limited to these numerical values because they differ depending on the specifications of the motor 300.

As described above, the phase-to-phase voltage varies in accordance with the load, that is, as illustrated in FIG. 9, there is a relationship that the phase-to-phase voltage decreases as the load torque increases due to toner clogging. The phase-to-phase voltage of the motor 300 is acquired using the relationship illustrated in FIG. 9 to determine a sign of toner clogging.

Here, criteria for determining the phase-to-phase voltage include, for example, four stages of a normal state, a slightly clogged state, a warning state, and a toner clogging occurring state. The normal state is, for example, in a range between 1.3 V or more and 24 V or less. The value of 24 V is an example of the third threshold. The slightly clogged state and the warning state are each an example of a toner clogging predictive state. The slightly clogged state is, for example, in a range between 0.87 V or more and 1.29 V or less. The value of 1.29 V is an example of the second threshold. The warning state is, for example, in a range between 0.67 V or more and 0.86 V or less. Note that, the toner clogging predictive state is discriminated as two states in this example, but may be, for example, in a range between 0.67 V or more and 1.29 V or less. The toner clogging occurring state is, for example, in a range between 0 V or more and 0.66 V or less. The value of 0.66 V is an example of the first threshold.

Here, in a case where the phase-to-phase voltage repeatedly acquired at the zero-cross timing is within a predetermined range for a predetermined number of times in a row, the sign detection unit 201C may determine a sign of toner clogging. To be specific, in a case where the phase-to-phase voltage is in a range between 0.67 V or more and 1.29 V or less for N (N is, for example, an integer from 2 or more to 10 or less) times in a row, the toner clogging predictive state may be determined.

When determining occurrence of toner clogging, that is, the toner clogging occurring state, the alert unit 201D performs control such that the image forming apparatus 10 stops. Furthermore, when determining a sign of toner clogging, that is, the toner clogging predictive state, the alert unit 201D provides a notification that there is the sign of the toner clogging. The alert unit 201D may display the notification that there is the sign of the toner clogging, on a screen of the image forming apparatus 10, for example, a screen of the display unit 205. Desirably, this notification includes a message prompting contact with a person in charge of maintenance service. Furthermore, the alert unit 201D may transmit the notification that there is the sign of the toner clogging, to the external server apparatus 350 via the communication unit 207. In this case, the server apparatus 350 transmits a message prompting the person in charge of maintenance service to make a response.

Providing the notification that the image forming apparatus 10 is in the toner clogging predictive state to the user or the person in charge of maintenance service shortens the operation stop period of the apparatus. At this time, the degree of toner clogging may be estimated from the phase-to-phase voltage and displayed in real time (for example, displayed in the unit %).

Furthermore, although the case where the phase-to-phase voltage between the A phase and the A-phase is acquired has been described above, the phase-to-phase voltage between the B phase and the B-phase may also be acquired. By acquiring the phase-to-phase voltages for two phases, the cycle of monitoring the phase-to-phase voltage per phase can be doubled.

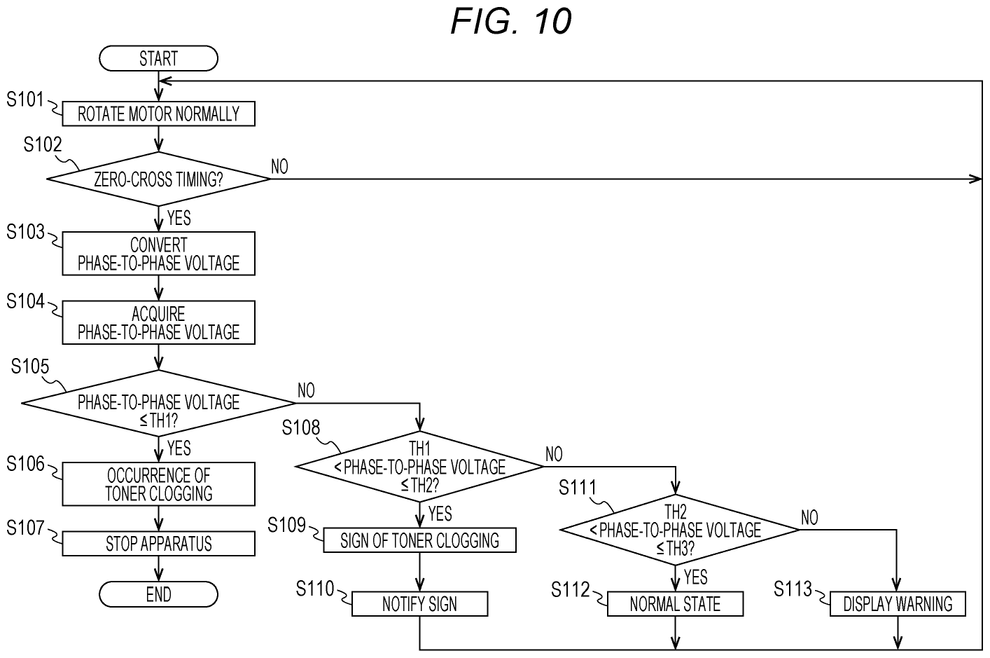

Next, the action of the image forming apparatus 10 according to the exemplary embodiment will be described with reference to FIG. 10.

FIG. 10 is a flowchart illustrating an example of a flow of processing by the toner clogging detection program 202A according to the exemplary embodiment.

First, the toner clogging detection program 202A is activated by the CPU 201 of the image forming apparatus 10, and the following steps are executed.

In step S101 of FIG. 10, the CPU 201 controls the motor 300 such that the motor 300 rotates normally, and starts to monitor a phase-to-phase voltage (e.g., the voltage between the A phase and the A-phase).

In step S102, the CPU 201 determines whether the motor 300 is at the zero-cross timing. When it is determined that the motor 300 is at the zero-cross timing (when the determination is positive), the processing proceeds to step S103. When it is determined that the motor 300 is not at the zero-cross timing (when the determination is negative), the processing returns to step S101, and step S101 is executed again.

In step S103, the CPU 201 controls the ADC 312, and the ADC 312 converts an analog signal of the phase-to-phase voltage at the zero-cross timing into a digital signal.

In step S104, the CPU 201 acquires the digital signal of the phase-to-phase voltage at the zero-cross timing from the ADC 312.

In step S105, the CPU 201 determines whether the phase-to-phase voltage acquired in step S104 is lower than or equal to a first threshold TH1 (e.g., 0.66 V). When it is determined that the phase-to-phase voltage is lower than or equal to the first threshold TH1 (when the determination is positive), the processing proceeds to step S106. When it is determined that the phase-to-phase voltage is higher than the first threshold TH1 (when the determination is negative), the processing proceeds to step S108.

In step S106, the CPU 201 determines that toner clogging has occurred in the waste toner collection path 99. It may be determined that the toner clogging has occurred when the phase-to-phase voltage is lower than or equal to the first threshold TH1 for a plurality of times in a row.

In step S107, the CPU 201 performs control such that the image forming apparatus 10 stops, and ends a series of processing by the toner clogging detection program 202A.

On the other hand, in step S108, the CPU 201 determines whether the phase-to-phase voltage acquired in step S104 is higher than the first threshold TH1 and lower than or equal to a second threshold TH2 (e.g., 1.29 V). When it is determined that the phase-to-phase voltage is higher than the first threshold TH1 and lower than or equal to the second threshold TH2 (when the determination is positive), the processing proceeds to step S109. When it is determined that the phase-to-phase voltage is higher than the second threshold TH2 (when the determination is negative), the processing proceeds to step S111.

In step S109, the CPU 201 determines that there is a sign of toner clogging in the waste toner collection path 99. Note that it may be determined that there is a sign of toner clogging when the phase-to-phase voltage is higher than the first threshold TH1 and lower than or equal to the second threshold TH2 for a plurality of times in a row.

In step S110, the CPU 201 provides a notification that there is a sign of toner clogging in the waste toner collection path 99. The processing then returns to step S101, and step S101 is executed again. As described above, the notification may be provided, for example, by displaying a message on the screen of the display unit 205 to prompt contact with a person in charge of maintenance service. Alternatively, the notification may be transmitted to the server apparatus 350, and the server apparatus 350 may prompt the person in charge of maintenance service to make a response.

On the other hand, in step S111, the CPU 201 determines whether the phase-to-phase voltage acquired in step S104 is higher than the second threshold TH2 and lower than or equal to a third threshold TH3 (e.g., 24 V). When it is determined that the phase-to-phase voltage is higher than the second threshold TH2 and lower than or equal to the third threshold TH3 (when the determination is positive), the processing proceeds to step S112. When it is determined that the phase-to-phase voltage is higher than the third threshold TH3 (when the determination is negative), the processing proceeds to step S113.

In step S112, the CPU 201 determines that the image forming apparatus 10 is in a normal state without toner clogging in the waste toner collection path 99. The processing then returns to step S101, and step S101 is executed again.

On the other hand, in step S113, the CPU 201 provides a warning indication because the phase-to-phase voltage is excessively high. The processing then returns to step S101, and step S101 is executed again.

As described above, according to the exemplary embodiment, a sign of toner clogging in the waste toner collection path can be detected without using an additional sensor or the like. Further, contamination in the apparatus owing to the waste toner can be suppressed, and the operation stop period of the apparatus can be shortened.

In each of the exemplary embodiments, the processor refers to a processor in a broad sense, and includes general-purpose processors (e.g., a central processing unit (CPU) and the like) and dedicated processors (e.g., a graphics processing unit (GPU), an application specific integrated circuit (ASIC), a field programmable gate array (FPGA), a programmable logic device, and the like).

In addition, the operation of the processor in each of the exemplary embodiments may be performed not only by one processor but also by a plurality of processors existing at physically separated positions in cooperation with each other. In addition, the order of the respective operations of the processor is not limited to only the order described in each of the exemplary embodiments, and may be appropriately changed.

The image forming apparatus according to the exemplary embodiment has been described above as an example. The exemplary embodiment may be in the form of programs for causing a computer to execute the functions of the units included in the image forming apparatus. The exemplary embodiment may be in the form of a non-transitory computer-readable storage medium storing these programs.

In addition, the configuration of the image forming apparatus described in the exemplary embodiment is an example, and may be changed according to the situation within a range not departing from the scope of the present disclosure.

In addition, the flow of the processing by the program described in the exemplary embodiment is also an example, and an unnecessary step may be deleted, a new step may be added, or the processing order may be changed within a range not departing from the scope of the present disclosure.

In the exemplary embodiment, the case where the processing according to the exemplary embodiment is realized by a software configuration using a computer by executing a program has been described, but the present disclosure is not limited thereto. The exemplary embodiment may be implemented by, for example, a hardware configuration or a combination of a hardware configuration and a software configuration.

With respect to the exemplary embodiments, the following supplementary notes are further disclosed.

### (Supplementary Notes)

(((1)))

An image forming apparatus comprising:
a waste toner collection path through which waste toner is collected;
a motor that drives a conveyance member provided in the waste toner collection path; and
a processor that acquires a phase-to-phase voltage which is at least one in-phase voltage of the motor, and detects a sign of toner clogging in the waste toner collection path, based on a variation in the phase-to-phase voltage.
   (((2)))

The image forming apparatus according (((1))), wherein
the processor acquires the phase-to-phase voltage at a zero-cross timing which is a timing at which an in-phase current when the motor is driven becomes zero.
   (((3)))

The image forming apparatus according to (((2))), wherein
when the phase-to-phase voltage repeatedly acquired at the zero-cross timing is within a predetermined range for a predetermined number of times in a row, the processor determines the sign of the toner clogging.
   (((4)))

The image forming apparatus according to (((2))) or (((3))), wherein
the processor determines occurrence of the toner clogging when the phase-to-phase voltage acquired at the zero-cross timing is lower than or equal to a first threshold, determines the sign of the toner clogging when the phase-to-phase voltage is higher than the first threshold and lower than or equal to a second threshold, and determines a normal state when the phase-to-phase voltage is higher than the second threshold and lower than or equal to a third threshold.
   (((5)))

The image forming apparatus according to (((4))), wherein
the processor, when determining the occurrence of the toner clogging, stops the image forming apparatus.
   (((6)))

The image forming apparatus according to (((4))), wherein
the processor, when determining the sign of the toner clogging, provides a notification that there is the sign of the toner clogging.
   (((7)))

The image forming apparatus according to (((6))), wherein
the processor causes the notification to be displayed on a screen of the image forming apparatus, and
the notification includes a message prompting contact with a person in charge of maintenance service.
   (((8)))

The image forming apparatus according to (((6))), wherein
the processor transmits the notification to an external server apparatus, and
the server apparatus transmits a message prompting a person in charge of maintenance service to make a response.
   (((9)))

The image forming apparatus according to any one of (((1))) to (((8))), wherein
the motor is a stepping motor.
   (((10)))

A non-transitory computer-readable storage medium storing a toner clogging detection program for an image forming apparatus including a waste toner collection path through which waste toner is collected, and a motor that drives a conveyance member provided in the waste toner collection path, the toner clogging detection program causing a computer to execute processing of:
acquiring a phase-to-phase voltage which is at least one in-phase voltage of the motor; and
detecting a sign of toner clogging in the waste toner collection path, based on a variation in the phase-to-phase voltage.

What is claimed is:

1. An image forming apparatus comprising:
a waste toner collection path through which waste toner is collected;
a motor that drives a conveyance member provided in the waste toner collection path; and
a processor that acquires a phase-to-phase voltage which is at least one in-phase voltage of the motor, and detects a sign of toner clogging in the waste toner collection path, based on a variation in the phase-to-phase voltage.

2. The image forming apparatus according to claim 1, wherein
the processor acquires the phase-to-phase voltage at a zero-cross timing which is a timing at which an in-phase current when the motor is driven becomes zero.

3. The image forming apparatus according to claim 2, wherein
when the phase-to-phase voltage repeatedly acquired at the zero-cross timing is within a predetermined range for a predetermined number of times in a row, the processor determines the sign of the toner clogging.

4. The image forming apparatus according to claim 2, wherein
the processor determines occurrence of the toner clogging when the phase-to-phase voltage acquired at the zero-cross timing is lower than or equal to a first threshold, determines the sign of the toner clogging when the phase-to-phase voltage is higher than the first threshold and lower than or equal to a second threshold, and determines a normal state when the phase-to-phase voltage is higher than the second threshold and lower than or equal to a third threshold.

5. The image forming apparatus according to claim 4, wherein
the processor, when determining the occurrence of the toner clogging, stops the image forming apparatus.

6. The image forming apparatus according to claim 4, wherein
the processor, when determining the sign of the toner clogging, provides a notification that there is the sign of the toner clogging.

7. The image forming apparatus according to claim 6, wherein
the processor causes the notification to be displayed on a screen of the image forming apparatus, and
the notification includes a message prompting contact with a person in charge of maintenance service.

8. The image forming apparatus according to claim 6, wherein
the processor transmits the notification to an external server apparatus, and
the server apparatus transmits a message prompting a person in charge of maintenance service to make a response.

9. The image forming apparatus according to claim 1, wherein
the motor is a stepping motor.

10. A non-transitory computer-readable storage medium storing a toner clogging detection program for an image forming apparatus including a waste toner collection path through which waste toner is collected, and a motor that drives a conveyance member provided in the waste toner collection path, the toner clogging detection program causing a computer to execute processing of:
acquiring a phase-to-phase voltage which is at least one in-phase voltage of the motor; and
detecting a sign of toner clogging in the waste toner collection path, based on a variation in the phase-to-phase voltage.
